(19) United States
(12) Patent Application Publication
(10) Pub. No.: US 2017/0276151 A1
(43) Pub. Date: Sep. 28, 2017

(54) HYDRAULIC CIRCUIT FOR CONSTRUCTION EQUIPMENT

(71) Applicants: JOUNG Hea-Gyoon, Busan (KR); VOLVO CONSTRUCTION EQUIPMENT AB, Eskilstuna (SE)

(72) Inventor: Hea-Gyoon Joung, Busan (KR)

(73) Assignee: VOLVO CONSTRUCTION EQUIPMENT AB, Eskilstuna (SE)

(21) Appl. No.: 15/512,382

(22) PCT Filed: Sep. 19, 2014
(86) PCT No.: PCT/KR2014/008745

§ 371 Date: Mar. 17, 2017

(51) Int. Cl. F15B 11/10; F15B 21/14; E02F 9/22; F15B 13/02

(52) U.S. Cl. CPC F15B 11/10; F15B 13/027; F15B 21/14; E02F 9/2292; E02F 9/2285; E02F 9/2282; E02F 9/2267; E02F 9/2271; E02F 9/2217; E02F 9/2296; E02F 9/2235; F15B 2211/20546; F15B 2211/41554; F15B 2211/428; F15B 2211/6052; F15B 2211/6346; F15B 2211/6313; F15B 2211/6355; F15B 2211/7053

(57) ABSTRACT

Disclosed is a hydraulic circuit for construction equipment for controlling to selectively supply a hydraulic oil from a hydraulic pump to a hydraulic cylinder for driving a boom. The hydraulic circuit for construction equipment, according to the present invention, comprises: a hydraulic cylinder driven by a hydraulic oil of a hydraulic pump; a direction control valve installed on the oil passage between the hydraulic pump and the hydraulic cylinder; an operating device installed on the oil passage between a pilot pump and the direction control valve; a center by-pass switching valve installed at the most downstream side of a center by-pass passage of the hydraulic pump; a pressure detection sensor that detects the pressure of a hydraulic oil at the large chamber side of the hydraulic cylinder; a jack-up switching valve installed on the oil passage between the operating device and the center by-pass switching valve; and a flow control valve installed in the spool of the direction control valve.

### TECHNICAL FIELD

The present disclosure relates to construction equipment, and more particularly, to a hydraulic circuit system for construction equipment that controls hydraulic fluid to be selectively supplied to a hydraulic cylinder driving a boom, by a hydraulic pump.

### BACKGROUND ART

FIG. 1 is a diagram of a conventional hydraulic circuit for construction equipment.

As illustrated in FIG. 1, a hydraulic cylinder 2 is connected to a variable displacement hydraulic pump (hereinafter referred to as a hydraulic pump) 1, such that the hydraulic cylinder 2 is driven by hydraulic fluid supplied by the variable displacement hydraulic pump 1. A directional control valve (MCV) 3 is disposed on a path between the hydraulic pump 1 and the hydraulic cylinder 2 to control a flow of hydraulic fluid supplied to and discharged from the hydraulic cylinder 2.

A control device 4 is disposed on a path between a pilot pump 5 and the directional control valve 3 to output a control signal to control the directional control valve 3. A jack-up control valve 6 is disposed on a path between the control device 4 and the hydraulic cylinders 2. The jack-up control valve 6 is switched to an on position by pressure on a large chamber side when the pressure on the large chamber side of the hydraulic cylinder 2 exceeds a preset value of pressure.

The on position of the jack-up control valve 6 means that pilot pressure generated by an operation of the control device 4 cannot be applied to a central bypass control valve 7, while the pilot pump 5 can apply hydraulic fluid to a control valve 8b of a flow control valve 8 as pilot pressure.

The central bypass control valve 7 is disposed farthest downstream of a central bypass passage 1a connected to the hydraulic pump 1. The central bypass control valve 7 is switched when the pilot pressure generated by the operation of the control device 4 is applied thereto through the jack-up control valve 6.

The flow control valve 8 is disposed on a path between a meter-in port of the directional control valve 3 and the hydraulic pump 1. The flow control valve 8 is switched by the pilot pressure passing through the jack-up control valve 6 when the jack-up control valve 6 is switched to the on position. The flow control valve 8 includes a poppet valve 8a and the control valve 8b for connecting or disconnecting a back pressure chamber of the poppet valve 8a to or from the meter-in port of the directional control valve 3.

When the control device 4 is operated to lower the boom, hydraulic fluid is supplied, as the pilot pressure, by the pilot pump 5, to a right signal pressure port of the directional control valve 3 through the control device 4.

This switches a spool of the directional control valve 3 to the left in the drawing, so that hydraulic fluid is supplied, by the hydraulic pump 1, sequentially through the poppet valve 8a of the flow control valve 8 and the directional control valve 3, to a small chamber of the hydraulic cylinder 2.

At this time, hydraulic fluid discharged from the large chamber of the hydraulic cylinder 2 is returned to a hydraulic fluid tank T through the directional control valve 3. Consequently, the boom can be lowered when the hydraulic cylinder 2 is driven to retract.

When the pressure generated in the large chamber of the hydraulic cylinder 2, while the boom is lowered in response to the retraction operation of the hydraulic cylinder 2, exceeds a preset pressure, the pressure on the large chamber side of the hydraulic cylinder 2 is applied to the side of the jack-up control valve 6 facing away from a valve spring 6a as pilot pressure. Consequently, the spool of the jack-up control valve 6 is switched to the on position.

At this time, the pilot pressure of the control device 4 is not applied to the central bypass control valve 7 due to the switching of the jack-up control valve 6 and thus, the central bypass control valve 7 is maintained in an initial position in which an opening thereof is opened by the elastic force of a valve spring.

The pilot pressure passing through the jack-up control valve 6, supplied by the pilot pump 5, is applied to the side of the control valve 8b of the flow control valve 8 facing away from the valve spring to switch the spool to the on position.

That is, the path between the back pressure chamber of the poppet valve 8a and the meter-in port of the directional control valve 3 is blocked. Thus, the opening of the flow control valve 8 remains closed.

Thus, hydraulic fluid from the hydraulic pump 1 is returned to the hydraulic fluid tank T, sequentially through the directional control valve 3 and the central bypass control valve 7.

When the boom is lowered by its own weight as described above, the hydraulic pump 1 does not supply hydraulic fluid to the small chamber of the hydraulic cylinder 2. This can consequently reduce the amount of horsepower required to drive the hydraulic pump 1, thereby improving the efficiency of hydraulic energy.

When the pressure generated in the large chamber of the hydraulic cylinder 2 driven to retract by the downward movement of the boom is lower than the preset pressure (for example, when a bucket comes into contact with the ground due to the downward movement of the boom), the jack-up control valve 6 is maintained in the initial position by the elastic force of the valve spring 6a (i.e. the hydraulic pressure on the large chamber side of the hydraulic cylinder 2 is lower than the elastic force of the valve spring 6a).

The initial position of the jack-up control valve 6 means that the pilot pressure generated by the operation of the control device 4 can be applied to the central bypass control valve 7 but the pilot pump 5 cannot apply hydraulic fluid, as the pilot pressure, to the control valve 8b of the flow control valve 8.

At this time, the pilot pressure of the control device 4 is applied to the signal pressure port of the central bypass control valve 7 through the jack-up control valve 6, thereby switching the spool to the on position. Thus, the opening of the central bypass control valve 7 is switched to a closed position.

In addition, the pilot pump 5 does not apply hydraulic fluid, as the pilot pressure, to the control valve 8b of the flow control valve 8 due to the switching of the jack-up control valve 6. Thus, the control valve 8b is maintained in the initial open position by the elastic force of the valve spring (i.e. a case in which the back pressure chamber of the poppet valve 8a is allowed to communicate with the meter-in port of the directional control valve 3). The opening of the flow control valve 8 is thus switched to the open position.

Consequently, the hydraulic pump 1 supplies hydraulic fluid to the small chamber of the hydraulic cylinder 2, sequentially through the poppet valve 8a and the directional control valve 3. As a result, the jack-up operation can be performed in response to the retraction operation of the hydraulic cylinder 2.

In the meantime, when the control valve 8b of the flow control valve 8 remains in the initial position with no pilot pressure being applied thereto, the opening of the flow control valve 8 is switched to the open position by the elastic force of the valve spring. Thus, hydraulic fluid from the hydraulic pump 1 can pass sequentially through the poppet valve 8a of the flow control valve 8 and the directional control valve 3, thereby driving the hydraulic cylinder 2 to extend.

That is, even in a case in which the hydraulic cylinder 2 is driven to extend, hydraulic fluid from the hydraulic pump 1 is supplied to the meter-in port of the directional control valve 3 through the poppet valve 8a. In other words, since hydraulic fluid from the hydraulic pump 1 is introduced into the meter-in port of the directional control valve 3 through the flow control valve 8, undesirable pressure loss is caused.

Further, when the hydraulic cylinder 2 is driven to extend to raise the boom, a reverse flow of hydraulic fluid may occur when load pressure subjected to the hydraulic cylinder 2 is higher than the hydraulic pressure of hydraulic fluid supplied by the hydraulic pump 1. That is, a load check function of preventing the reverse flow using the flow control valve 8 so that the hydraulic cylinder 2 is not driven to retract may not be properly performed, which is problematic.

### DISCLOSURE

### Technical Problem

Accordingly, the present disclosure has been made to solve the above-mentioned problems, and an object of the present disclosure is to provide a hydraulic circuit system for construction equipment that can control the flow rate of discharged hydraulic fluid by adjusting a swash plate of a hydraulic pump from the moment at which the weight of a piece of equipment has to be lifted by a jack-up operation and can selectively restrict the supply of hydraulic fluid from the hydraulic pump to a small chamber when a boom is lowered by its own weight, thereby increasing energy efficiency.

Also provided is a hydraulic circuit system for construction equipment that can prevent undesirable pressure loss when supplying hydraulic fluid to a hydraulic cylinder to raise a boom, and in the extension operation of the hydraulic cylinder, can prevent a reverse flow of hydraulic fluid when load pressure on the hydraulic cylinder side is higher than pressure on the hydraulic pump side.

### Technical Solution

According to an aspect of the present disclosure, provided is a hydraulic circuit system for construction equipment. The hydraulic circuit system may include:

a hydraulic pump and a pilot pump;

a hydraulic cylinder driven by hydraulic fluid supplied by the hydraulic pump;

a directional control valve disposed on a path between the hydraulic pump and the hydraulic cylinder to control a flow of hydraulic fluid supplied to and discharged from the hydraulic cylinder;

a control device disposed on a path between the pilot pump and the directional control valve to output a control signal to control the directional control valve;

a central bypass control valve disposed farthest downstream of a central bypass passage connected to the hydraulic pump, the central bypass control valve switched to close an opening thereof when receiving pilot pressure applied by the control device;

a pressure sensor detecting hydraulic pressure of hydraulic fluid on a large chamber side of the hydraulic cylinder;

a jack-up control valve disposed on a path between the control device and the central bypass control valve, the jack-up control valve switched to allow the control device to apply the pilot pressure to the central bypass control valve when receiving a first electrical signal; and

a flow control valve disposed in the directional control valve, wherein, in a retraction operation of the hydraulic cylinder, the flow control valve is switched to an on position to block a flow of hydraulic fluid from the hydraulic pump to a small chamber of the hydraulic cylinder when the hydraulic pressure of hydraulic fluid on the large chamber side exceeds a preset pressure and is switched to open an opening thereof to allow the flow of hydraulic fluid from the hydraulic pump to the small chamber of the hydraulic cylinder when the hydraulic pressure of hydraulic fluid on the large chamber side is equal to or lower than the preset pressure.

The hydraulic circuit system may further include a controller, wherein, in the retraction operation of the hydraulic cylinder, when the hydraulic pressure of hydraulic fluid on the large chamber side of the hydraulic cylinder is equal to or lower than the preset pressure, the controller applies the first electrical signal to the jack-up control valve to switch the jack-up control valve to close the opening of the central bypass control valve and applies a second electrical signal to a regulator controlling a swash plate angle of the hydraulic pump.

According to another aspect of the present disclosure, provided is a hydraulic circuit system for construction equipment. The hydraulic circuit system may include:

a hydraulic pump and a pilot pump;

a hydraulic cylinder driven by hydraulic fluid supplied by the hydraulic pump;

a directional control valve disposed on a path between the hydraulic pump and the hydraulic cylinder to control a flow of hydraulic fluid supplied to and discharged from the hydraulic cylinder;

a control device disposed on a path between the pilot pump and the directional control valve to output a control signal to control the directional control valve;

a pressure sensor detecting hydraulic pressure of hydraulic fluid on a large chamber side of the hydraulic cylinder;

a central bypass control valve disposed farthest downstream of a central bypass passage connected to the hydraulic pump, the central bypass control valve being switched to close an opening of a passage thereof when receiving pilot pressure;

a control valve disposed on a path between the pilot pump and the central bypass control valve, the control valve converting hydraulic fluid supplied by the pilot pump to the pilot pressure and applying the converted pilot pressure to the central bypass control valve when receiving a first electrical signal; and

a flow control valve disposed in the directional control valve, wherein, in a retraction operation of the hydraulic cylinder, the flow control valve is switched to an on position to block a flow of hydraulic fluid from the hydraulic pump to a small chamber of the hydraulic cylinder when the hydraulic pressure of hydraulic fluid on the large chamber side exceeds a preset pressure and is switched to open an opening thereof to allow the flow of hydraulic fluid from the hydraulic pump to the small chamber of the hydraulic cylinder when the hydraulic pressure of hydraulic fluid on the large chamber side is equal to or lower than the preset pressure.

The hydraulic circuit system may further include a controller, wherein, in the retraction operation of the hydraulic cylinder, when the hydraulic pressure of hydraulic fluid on the large chamber side of the hydraulic cylinder is equal to or lower than the preset pressure, the controller applies the first electrical signal to the control valve to switch the control valve to close the opening of the central bypass control valve and applies a second electrical signal to a regulator controlling a swash plate angle of the hydraulic pump.

The hydraulic circuit system may further include a load check valve disposed on a path between the hydraulic pump and a meter-in port of the directional control valve to prevent a reverse flow of hydraulic fluid if load pressure generated in the hydraulic cylinder is greater than hydraulic pressure of hydraulic fluid supplied by the hydraulic pump.

The flow control valve may be a pilot-operated control valve that switches between an initial position to allow the flow of hydraulic fluid from the hydraulic pump to the small chamber of the hydraulic cylinder to drive the hydraulic cylinder to retract and the on position to block the flow of hydraulic fluid from the hydraulic pump to the small chamber of the hydraulic cylinder in the retraction operation of the hydraulic cylinder.

The jack-up control valve may be a pilot-operated control valve that switches between an initial position in which an opening thereof is opened when the hydraulic pressure of hydraulic fluid on the large chamber side of the hydraulic cylinder is equal to or lower than the preset pressure and an on position in which the opening is closed when the hydraulic pressure of hydraulic fluid on the large chamber side of the hydraulic cylinder is higher than the preset pressure.

The directional control valve may have a regeneration passage through which the small chamber is supplemented with a portion of hydraulic fluid discharged from the large chamber in the retraction operation of the hydraulic cylinder.

The regeneration passage may have an orifice disposed therein, the orifice generating pilot pressure in the regeneration passage from the hydraulic fluid discharged from the large chamber to close the opening of the flow control valve by switching the flow control valve in the retraction operation of the hydraulic cylinder.

The control valve may be an electro proportional pressure reducing valve that converts the hydraulic fluid supplied by the pilot pump to the pilot pressure corresponding to the first electrical signal applied by a controller and applies the converted pilot pressure to the central bypass control valve.

The control valve may be a solenoid valve that is switched between an initial position to open the opening of the central bypass control valve and an on position to close the opening of the central bypass control valve by applying the hydraulic fluid supplied by the pilot pump, as the pilot pressure, to the central bypass control valve in response to the first electrical signal applied by the controller.

The hydraulic circuit system may further include a first pressure sensor and a second pressure sensor disposed on paths between the control device and the directional control valve to detect pilot pressures applied to the directional control valve when the control device is operated and input signals to the controller to enable the hydraulic pump to supply the hydraulic fluid to the hydraulic cylinder at a flow rate corresponding to a degree to which the control device is operated.

### Advantageous Effects

According to the present disclosure as set forth above, it is possible to adjust the power of the hydraulic pump by adjusting the swash plate from the moment at which the weight of a piece of equipment has to be lifted by the jack-up operation and restrict the flow of hydraulic fluid by selectively supplying hydraulic fluid to the small chamber when the boom is lowered by its own weight.

In addition, the use of a load check valve can prevent a reverse flow of hydraulic fluid that would otherwise occur when pressure on the hydraulic cylinder side is higher than the hydraulic pressure on the hydraulic pump side in the extension operation of the hydraulic cylinder, thereby improving the reliability of the operation of equipment. In addition, undesirable pressure loss can be prevented when hydraulic fluid is supplied to the hydraulic cylinder for the boom-up operation.

### DESCRIPTION OF DRAWINGS

FIG. 1 is a diagram of a conventional hydraulic circuit for construction equipment;

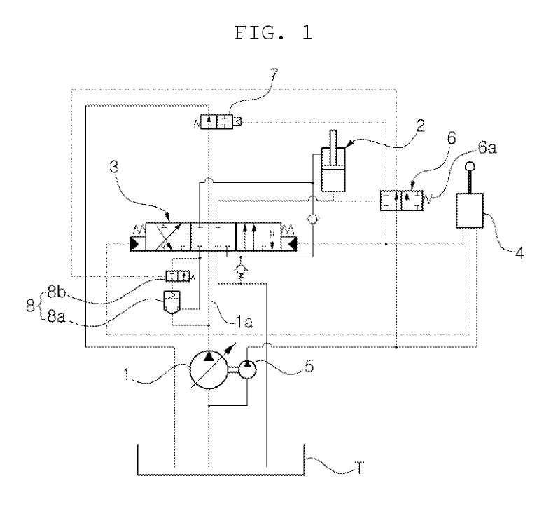

FIG. 2 is a diagram of a hydraulic circuit system for construction equipment according to an exemplary embodiment, in which a large chamber supplies hydraulic fluid to a small chamber to perform hydraulic fluid regeneration when a hydraulic cylinder is driven to retract;

FIG. 3 is a diagram of the hydraulic circuit system for construction equipment, in which a hydraulic pump supplies hydraulic fluid to the small chamber to perform a jack-up operation when the hydraulic cylinder is driven to retract;

FIG. 4 is a diagram of a hydraulic circuit system for construction equipment according to another embodiment, in which a large chamber supplies hydraulic fluid to a small chamber to perform hydraulic fluid regeneration when a hydraulic cylinder is driven to retract;

FIG. 5 is a diagram of the hydraulic circuit system for construction equipment, in which a hydraulic pump supplies hydraulic fluid to the small chamber to perform a jack-up operation when the hydraulic cylinder is driven to retract; and

FIG. 6 is a diagram of a hydraulic circuit system applied to an excavator according to an exemplary embodiment.

### DESCRIPTION OF THE REFERENCE NUMERALS IN THE DRAWINGS

1: hydraulic pump
2: hydraulic cylinder
3: directional control valve
4: control device (RCV)
5: pilot pump
6: jack-up control valve
7: central bypass control valve
8: pressure sensor
9: controller
10: flow control valve
11: regulator
12: regeneration passage
13: orifice
14: load check valve
15: holding check valve

### BEST MODE

Hereinafter, a hydraulic circuit system for construction equipment according to exemplary embodiments of the present disclosure will be described in detail with reference to the accompanying drawings.

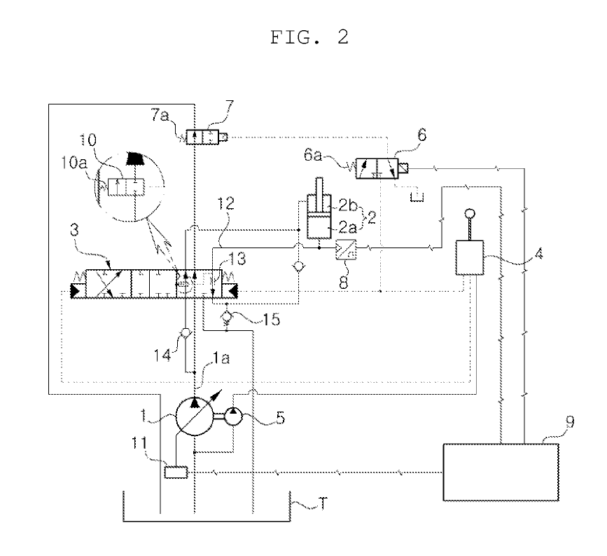

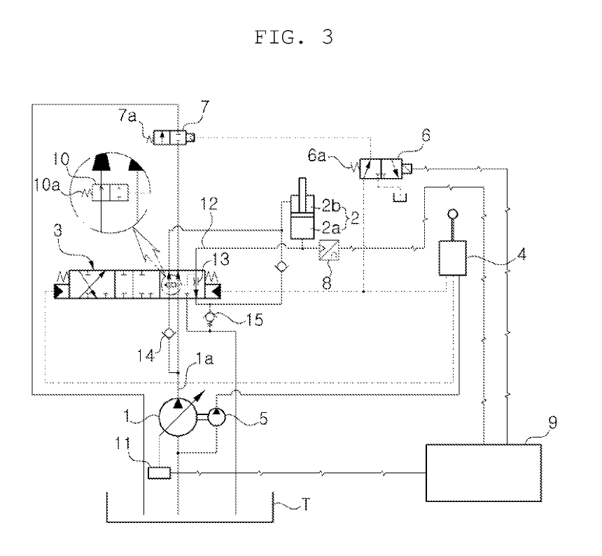

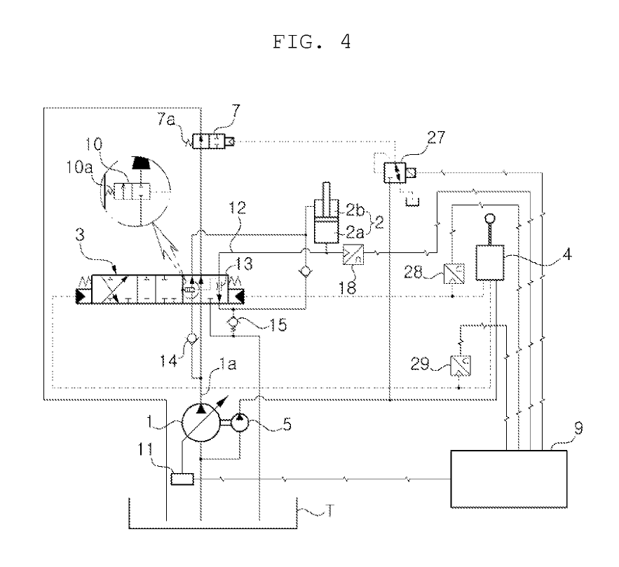

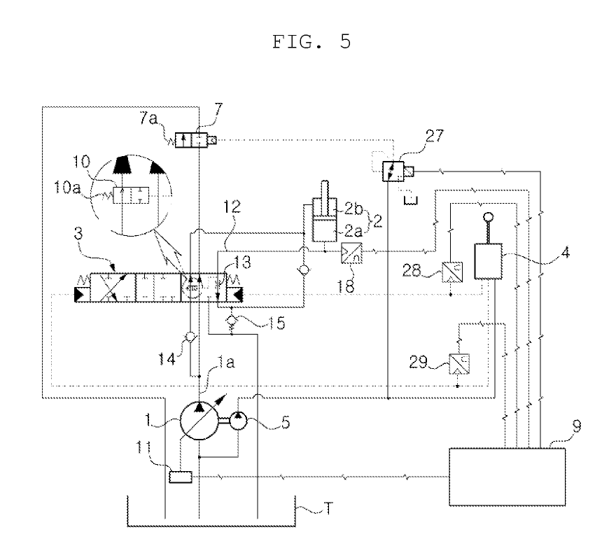

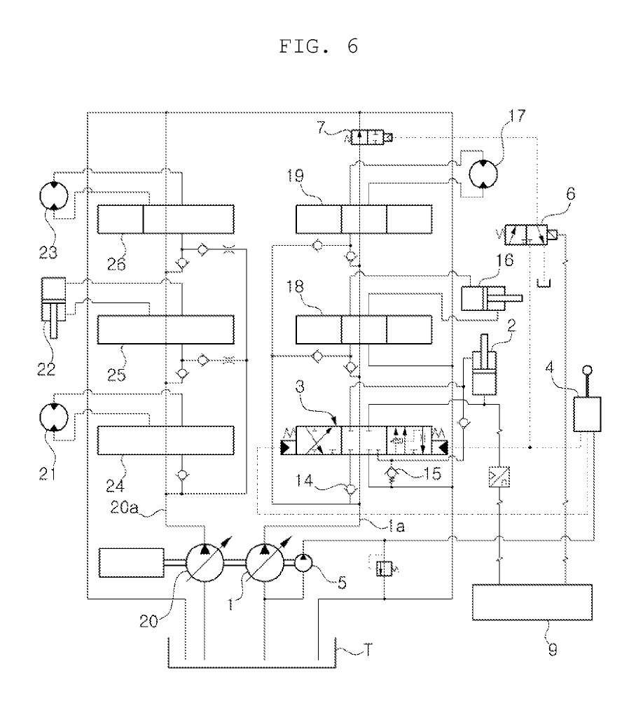

FIG. 2 is a diagram of a hydraulic circuit system for construction equipment according to an exemplary embodiment, in which a large chamber supplies hydraulic fluid to a small chamber to perform hydraulic fluid regeneration when a hydraulic cylinder is driven to retract, FIG. 3 is a diagram of the hydraulic circuit system for construction equipment, in which a hydraulic pump supplies hydraulic fluid to the small chamber to perform a jack-up operation when the hydraulic cylinder is driven to retract, FIG. 4 is a diagram of a hydraulic circuit system for construction equipment according to another embodiment, in which a large chamber supplies hydraulic fluid to a small chamber to perform hydraulic fluid regeneration when a hydraulic cylinder is driven to retract, FIG. 5 is a diagram of the hydraulic circuit system for construction equipment, in which a hydraulic pump supplies hydraulic fluid to the small chamber to perform a jack-up operation when the hydraulic cylinder is driven to retract, and FIG. 6 is a diagram of a hydraulic circuit system applied to an excavator according to an exemplary embodiment.

Referring to FIGS. 2, and 6, the hydraulic circuit system for construction equipment according to the exemplary embodiment will be described.

A hydraulic cylinder 2 is connected to a variable displacement hydraulic pump 1 (hereinafter referred to as a hydraulic pump) such that the hydraulic cylinder is driven by hydraulic fluid supplied by the hydraulic pump 1. A directional control valve (MCV) 3 is disposed on a path between the hydraulic pump 1 and the hydraulic cylinder 2 to control the flow of hydraulic fluid supplied to or discharged from the hydraulic cylinder 2.

A control device 4 is disposed on a path between the pilot pump 5 and the directional control valve 3 to output a control signal to control the directional control valve 3.

A regeneration passage 12 is formed in a spool of the directional control valve 3 to supplement a small chamber 2b with a portion of hydraulic fluid discharged from a large chamber 2a when the hydraulic cylinder 2 is driven to retract.

A jack-up control valve 6 is disposed on a path between the control device 4 and the central bypass control valve 7 to apply pilot pressure generated by the operation of the control device 4 to the central bypass control valve 7 when switched by an electrical signal applied thereto.

The jack-up control valve 6 may be a pilot-operated control valve.

The pilot-operated control valve is switched between an initial position in which an opening thereof is opened when the hydraulic pressure on the large chamber side of the hydraulic cylinder 2 is equal to or lower than a preset pressure and an on position in which the opening is closed when the hydraulic pressure on the large chamber side of the hydraulic cylinder 2 is higher than the preset pressure.

The central bypass control valve 7 is disposed farthest downstream of a central bypass passage 1a of the hydraulic pump 1. The central bypass control valve 7 is switched to close the opening when the pilot pressure generated by the operation of the control device 4 is applied thereto through the jack-up control valve 6.

A pressure sensor 8 is disposed on a path between the directional control valve 3 and the large chamber 2a of the hydraulic cylinder 2 to detect the hydraulic pressure on the large chamber side of the hydraulic cylinder 2.

A flow control valve 10 is disposed in the directional control valve 3. The flow control valve 10 is switched by the pressure of hydraulic fluid discharged from the large chamber 2a of the hydraulic cylinder 2 when the hydraulic cylinder 2 is driven to retract.

In the retraction operation of the hydraulic cylinder 2, when the hydraulic pressure on the large chamber side exceeds a preset pressure, the flow control valve 10 is switched to an on position to prevent hydraulic fluid from the hydraulic pump 1 from being supplied to the small chamber 2b of the hydraulic cylinder 2 and a portion of hydraulic fluid from the large chamber 2a is supplied to the small chamber 2b. When the hydraulic pressure on the large chamber side is equal to or lower than the preset pressure, the flow control valve 10 opens the opening using a valve spring 10a to supply hydraulic fluid to the small chamber 2b of the hydraulic cylinder 2 by the hydraulic pump 1.

A controller 9 is connected to the pressure sensor 8 and the regulator 11. In the retraction operation of the hydraulic cylinder 2, when the hydraulic pressure on the large chamber side of the hydraulic cylinder 2 is equal to or lower than the preset pressure, the controller 9 switches the jack-up control valve 6 by applying an electrical signal to the jack-up control valve 6 to close the opening of the central bypass control valve 7 and applies an electrical signal to a regulator 11 regulating the swash plate angle of the hydraulic pump 1 to allow hydraulic fluid to be selectively discharged by the hydraulic pump 1.

An orifice 12 is disposed on a regeneration passage 12 connecting the large chamber 2a and the small chamber 2b of the hydraulic cylinder to switch the flow control valve 10 to the on position using the pressure of hydraulic fluid discharged from the large chamber 2a in the retraction operation of the hydraulic cylinder 2.

The flow control valve 10 may be a pilot-operated control valve that is switched between an initial position in which hydraulic fluid is supplied to the small chamber 2b of the hydraulic cylinder 2 by the hydraulic pump 1 to drive the hydraulic cylinder 2 to retract and an on position in which the supply of hydraulic fluid to the small chamber 2b of the hydraulic cylinder 2 by the hydraulic pump 1 is stopped in the retraction operation of the hydraulic cylinder 2.

A load check valve 14 is disposed on a path between the hydraulic pump 1 and the meter-in port of the direction control valve 3 to prevent a reverse flow of hydraulic fluid when load pressure generated in the hydraulic cylinder 2 is higher than the hydraulic pressure of the hydraulic pump 1 when the hydraulic cylinder 2 is driven to extend.

According to the above-mentioned configuration, as illustrated in FIGS. 2 and 3, when the control device 4 is operated to lower the boom of an excavator, the pilot pump 5 supplies hydraulic fluid, as pilot pressure, to a right signal pressure port of the directional control valve 3 through the control device 4. As a result, the spool of the directional control valve 3 can be switched to the left in the drawings.

At the same time, the pilot pressure generated by the operation of the control device 4 is applied to the signal pressure port of the central bypass control valve 7 through the jack-up control valve 6, the opening of which is opened by the elastic force of the valve spring 6a. Accordingly, the spool of the central bypass control valve 7 is switched to the left in the drawings to close the opening of the central bypass control valve 7.

Thus, hydraulic fluid is supplied to the small chamber 2b of the hydraulic cylinder 2 by the hydraulic pump 1, sequentially through the load check valve 14 and the directional control valve 3. At this time, hydraulic fluid discharged from the large chamber 2a of the hydraulic cylinder 2 is returned to a hydraulic fluid tank T through the directional control valve 3. Consequently, the boom can be lowered in response to the retraction operation of the hydraulic cylinder 2.

In the retraction operation of the hydraulic cylinder 2, when the pressure of hydraulic fluid discharged from the large chamber 2a of the hydraulic cylinder 2 exceeds the preset pressure (e.g. in driving conditions in which the boom is lowered by its own weight), the hydraulic pressure of the large chamber 2a is applied as pilot pressure to the side of the flow control valve 10 facing away from the valve spring 10a through the orifice 12 disposed on the regeneration passage 12, so that the spool of the flow control valve 10 is switched to the left in the drawings. That is, the flow control valve 10 is switched to the on position, thereby closing the opening.

At the same time, the central bypass control valve 7 is switched to the right in the drawings by the elastic force of the valve spring 7a, since the pilot pressure generated in response to the operation of the control device 4 is not applied thereto. That is, since the central bypass control valve 7 is maintained in the initial position by the elastic force of the valve spring 7a, the opening is opened.

Thus, hydraulic fluid from the hydraulic pump 1 is returned to the hydraulic fluid tank T, sequentially through the directional control valve 3 and the central bypass control valve 7, so that hydraulic fluid is not supplied to the small chamber 2b of the hydraulic cylinder 2 by the hydraulic pump 1.

Here, the small chamber 2b is supplemented with a portion of hydraulic fluid discharged from the large chamber 2a of the hydraulic cylinder 2 through the regeneration passage 12 of the directional control valve 3, so the supplementary portion of hydraulic fluid is regenerated. At the same time, a portion of hydraulic fluid discharged from the large chamber 2a is returned to the hydraulic fluid tank T through the directional control valve 3 and a holding check valve 15.

In the case in which the boom is lowered by its own weight as described above, hydraulic fluid is not supplied to the small chamber 2b of the hydraulic cylinder 2 by the hydraulic pump 1, but a portion of hydraulic fluid in the large chamber 2a is supplied to the small chamber 2b. Accordingly, the power consumption of the hydraulic pump 1 is reduced, so that the efficiency of hydraulic energy can be improved.

In the retraction operation of the hydraulic cylinder 2, when the pressure of hydraulic fluid discharged from the large chamber 2a of the hydraulic cylinder 2 is equal to or lower than the preset pressure (e.g., a case in which the boom is lowered so that a bucket is brought into contact with the ground), the flow control valve 10 is maintained in the initial position by the elastic force of the valve spring 10a, so that the opening of the flow control valve 10 is opened.

At the same time, since the jack-up control valve 6 is maintained in the initial position by the elastic force of the valve spring 6a, the opening of the jack-up control valve 6 is opened. Consequently, the pilot pressure generated in response to the operation of the control device 4 is applied to the signal pressure port of the central bypass control valve 7 through the jack-up control valve 6. As a result, the central bypass control valve 7 is switched to the on position, so that the opening of the central bypass control valve 7 is closed.

Thus, hydraulic fluid is supplied to the small chamber 2b of the hydraulic cylinder 2 by the hydraulic pump 1, sequentially through the load check valve 14 and the flow control valve 10. That is, when the boom is lowered by its own weight so that the bucket comes into contact with the ground, hydraulic fluid supplied by the hydraulic pump 1 and a portion of hydraulic fluid discharged from the large chamber 2a of the boom cylinder 2 are supplied to the small chamber 2b of the hydraulic cylinder 2.

In addition, when the controller 9 determines the hydraulic pressure of the large chamber 2a to be equal to or lower than a preset value based on an input detection signal obtained by the pressure sensor 8 detecting the hydraulic pressure of the large chamber 2a of the hydraulic cylinder 2, the controller 9 applies an electrical signal to the regulator 11 to maximize the output of the hydraulic pump 1. Consequently, the swash plate angle of the hydraulic pump 1 is adjusted to the maximum angle. The hydraulic pump 1 can supply hydraulic fluid to the small chamber 2b of the hydraulic cylinder 2 by maximizing the flow rate of the hydraulic fluid.

As a result, it is possible to increase jack-up power when a piece of equipment is jacked up. (A jack-up operation is performed, for example, when drawing out a piece of equipment having a heavy weight from a swamp by lifting the piece of equipment or when driving the piece of equipment down a steep slope while supporting the piece of equipment).

When the control device 4 is operated to bring the boom up, hydraulic fluid is supplied to the left signal pressure port of the directional control valve 3 through the control device 4 by the pilot pump 5. As a result, the spool of the directional control valve 3 is switched to the right in the drawings.

Then, hydraulic fluid is supplied to the large chamber 2a of the hydraulic cylinder 2 by the hydraulic pump 1, sequentially through the load check valve 14 and the directional control valve 3. At the same time, hydraulic fluid discharged from the small chamber 2b of the hydraulic cylinder 2 is returned to the hydraulic fluid tank T through the directional control valve 3.

Thus, the boom can be raised in response to the extension operation of the hydraulic cylinder 2. Here, when the hydraulic cylinder 2 is driven to extend by hydraulic fluid supplied by the hydraulic pump 1, since a separate flow control valve is not disposed on the path between the hydraulic pump 1 and the meter-in port of the directional control valve 3, undesirable pressure loss of hydraulic fluid can be prevented.

In the extension operation of the hydraulic cylinder 2, even when the load pressure generated in the hydraulic cylinder 2 is higher than the hydraulic pressure of the hydraulic pump 1, a reverse flow of hydraulic fluid is prevented by the load check valve 14, thereby improving the reliability of equipment.

As illustrated in FIG. 6, directional control valves 3, 18, and 19 are disposed in parallel on the central bypass passage 1a connected to the hydraulic pump 1. The directional control valves 3, 18, and 19 are switched by the pilot pressure applied thereto in response to the operation of the control device 4 and control the flow of hydraulic fluid selectively supplied to the hydraulic cylinder 2, a hydraulic cylinder (or bucket cylinder) 16, and a travel motor 17 by the hydraulic pump 1.

Furthermore, directional control valves 24, 25, and 26 are disposed in parallel on a central bypass passage 20a connected to a hydraulic pump 20. The directional control valves 24, 25, and 26 are switched by the pilot pressure applied thereto in response to the operation of the control device (not shown) and control flows of hydraulic fluid selectively supplied to a swing motor 21, a hydraulic cylinder (or arm cylinder) 22, and a travel motor 23 by the hydraulic pump 20.

The hydraulic cylinder 16 and the travel motor 17 that are driven by hydraulic fluid selectively supplied by the hydraulic pump 1 when the directional control valves 18 and 19 are switched, as well as the swing motor 21, the hydraulic cylinder 22, and the travel motor 23 that are driven by hydraulic fluid selectively supplied by the hydraulic pump 20 when the directional control valves 24, 25, and 26 are switched, are configured the same as those of conventional hydraulic circuit systems, so detailed descriptions thereof will be omitted.

Referring to FIGS. 4 and 5, a hydraulic circuit system for construction equipment according to another embodiment will now be described.

A hydraulic cylinder 2 is connected to a variable displacement hydraulic pump 1 (hereinafter referred to as a hydraulic pump) such that the hydraulic cylinder 2 is driven by hydraulic fluid supplied by the hydraulic pump 1. A directional control valve (MCV) 3 is disposed on a path between the hydraulic pump 1 and the hydraulic cylinder 2 to control the flow of hydraulic fluid supplied to and discharged from the hydraulic cylinder 2.

A control device 4 is disposed on a path between the pilot pump 5 and the directional control valve 3 to output a control signal to control the directional control valve 3.

A regeneration passage 12 is formed in the directional control valve 3 to supplement a small chamber 2b with a portion of hydraulic fluid discharged from a large chamber 2a when the hydraulic cylinder 2 is driven to retract.

A central bypass control valve 7 is disposed farthest downstream of a central bypass passage 1a connected to the hydraulic pump 1. The central bypass control valve 7 is switched to close an opening thereof when hydraulic fluid is supplied, as pilot pressure, through a control valve 27 by the pilot pump 5.

A pressure sensor 8 is disposed on a path between the directional control valve 3 and the large chamber 2a of the hydraulic cylinder 2 to detect the hydraulic pressure on the large chamber side of the hydraulic cylinder 2.

A flow control valve 10 is disposed in the directional control valve 3. The flow control valve 10 is switched by the pressure of hydraulic fluid discharged from the large chamber 2a of the hydraulic cylinder 2 in response to the retraction operation of the hydraulic cylinder 2.

The control valve 27 is disposed on a path between the pilot pump 5 and the central bypass control valve 7 to convert hydraulic fluid supplied by the pilot pump 5 to pilot pressure when switched by an electrical signal applied thereto. The control valve 27 applies the converted pilot pressure to the signal pressure port of the central bypass control valve 7 to switch the central bypass control valve to an on position.

The control valve 27 may be an electro proportional pressure reducing valve (PPRV).

The PPRV serves to convert hydraulic fluid supplied by the pilot pump 5 to the pilot pressure corresponding to an electrical signal applied by a controller 9 and apply the converted pilot pressure to the signal pressure port of the central bypass control valve 7.

Although not shown in the drawings, the control valve 27 may be a solenoid valve.

The solenoid valve is switched between an initial position and an on position. In the initial position, an opening of the central bypass control valve 7 is opened.

In the on position, the solenoid valve closes the opening of the central bypass control valve 7 by applying hydraulic fluid supplied by the pilot pump 5, as the pilot pressure, to the signal pressure port of the central bypass control valve 7, in response to an electrical signal applied by the controller 9.

The controller 9 is connected to the pressure sensor 8 and the regulator 11. In the retraction operation of the hydraulic cylinder 2, when the hydraulic pressure on the large chamber side of the hydraulic cylinder 2 is equal to or lower than the preset pressure, the controller 9 switches the control valve 27 by applying an electrical signal thereto to close the opening of the central bypass control valve 7 and applies an electrical signal to a regulator 11 regulating the swash plate angle of the hydraulic pump 1 to selectively discharge hydraulic fluid using the hydraulic pump 1.

First and second pressure sensors 28 and 29 are disposed on a path between the control device 4 and the directional control valve 3. To supply hydraulic fluid using the hydraulic pump 1 at a flow rate corresponding to the degree to which the control device 4 is operated, the first and second pressure sensors 28 and 29 serve to detect the pilot pressure applied to the directional control valve 3 in response to the operation of the control device 4 and input a detection signal to the controller 9.

Here, the configuration of the hydraulic circuit system, excluding the control valve 27 disposed on the path between the pilot pump 5 and the central bypass control valve 7 to be switched so that the opening thereof is opened in response to an electrical signal applied by the controller 9, as well as the first and second pressure sensors 28 and 29 disposed on the path between the control device 4 and the directional control valve 3 to detect the pilot pressure applied to the directional control valve 3 corresponding to the degree to which the control device 4 is operated and input a detection signal to the controller 9, is the same as that of the hydraulic circuit system according to the exemplary embodiment as previously described, so a detailed description thereof will be omitted.

According to the above-described configuration, in the retraction operation of the hydraulic cylinder 2, the pressure sensor 18 disposed on the path along which hydraulic fluid is supplied to the large chamber 2a of the hydraulic cylinder 2 detects the pressure of hydraulic fluid discharged from the large chamber 2a of the hydraulic cylinder 2 and inputs a detection signal to the controller 9.

When the hydraulic pressure on the large chamber side of the hydraulic cylinder 2 exceeds a preset pressure (e.g. in driving conditions in which the boom is lowered by its own weight), the hydraulic pressure of the large chamber 2a is applied to the side of the flow control valve 10 facing away from the valve spring 10a due to the orifice 12 disposed on the regeneration passage 12, so that the spool is switched to the left in the drawings. That is, since the flow control valve 10 is switched to the on position, the opening is closed.

At the same time, the control valve 27 prevents hydraulic fluid from the pilot pump 5 from being applied as the pilot pressure to the central bypass control valve 7, so that the central bypass control valve 7 is maintained in the initial position by the elastic force of the valve spring 7a. Consequently, the opening thereof is opened.

Thus, hydraulic fluid is returned to the hydraulic fluid tank T, sequentially through the directional control valve 3 and the central bypass control valve 7, so that hydraulic fluid is not supplied to the small chamber 2b of the hydraulic cylinder 2 by the hydraulic pump 1.

In the above-described driving condition in which the boom is lowered by its own weight, hydraulic fluid is not supplied to the small chamber 2b of the hydraulic cylinder 2 by the hydraulic pump 1, but a portion of hydraulic fluid in the large chamber 2a is supplied to the small chamber 2b. This can consequently reduce the power consumption of the hydraulic pump 1, thereby improving the efficiency of hydraulic energy.

In the retraction operation of the hydraulic cylinder 2, when the pressure of hydraulic fluid discharged from the large chamber 2a of the hydraulic cylinder 2 is equal to or lower than the preset pressure (for example, when the boom is lowered so that the bucket comes into contact with the ground), the flow control valve 10 is maintained in the initial position by the elastic force of the valve spring 10a, so that the opening thereof is opened.

At the same time, the opening of the control valve 27 is opened by an electrical signal applied by the controller 9. That is, the control valve 27 converts hydraulic fluid supplied by the pilot pump 5 to pilot pressure corresponding to the electrical signal, and then, applies the converted pilot pressure to the signal pressure port of the central bypass control valve 7. This consequently switches the central bypass control valve 7 to the on position, so that the opening of the central bypass control valve 7 is closed.

Thus, hydraulic fluid can be supplied to the small chamber 2b of the hydraulic cylinder 2 by the hydraulic pump 1, sequentially through the load check valve 14 and the flow control valve 10. Here, an electrical signal is applied to the regulator 11 by the controller 9 to maximize the output of the hydraulic pump 1. Consequently, the swash plate angle of the hydraulic pump 1 is adjusted to the maximum, so a maximum amount of hydraulic fluid can be discharged by the hydraulic pump 1 to the small chamber 2b of the hydraulic cylinder 2. It is thereby possible to increase jack-up power when performing the jack-up operation of heavy equipment with the bucket into contact with the ground.

On the other hand, in a driving conditions in which the hydraulic cylinder 2 is driven to retract, when the boom is lowered by its own weight, it is possible to drive the hydraulic cylinder 2 by forcedly supplying hydraulic fluid to the hydraulic cylinder 2 using the hydraulic pump 1. That is, the flow rate of hydraulic fluid supplied to the small chamber 2b of the hydraulic cylinder 2 can be controlled according to pilot pressure detected by the first pressure sensor 28 disposed on the path between the control device 4 and the directional control valve 3. Thus, boom-down speed can be adjusted by the retraction operation of the hydraulic cylinder 2, thereby increasing the pace of work.

### INDUSTRIAL APPLICABILITY

According to the present disclosure having the above-described configuration, when the boom is lowered by its own weight, the efficiency of hydraulic energy is increased by stopping the supply of hydraulic fluid to the hydraulic cylinder by the hydraulic pump. During the jack-up operation, the swash plate is adjusted to output a maximum amount of hydraulic fluid using the hydraulic pump. It is possible to advantageously increase jack-up force and thus, the pace of work.

1. A hydraulic circuit system for construction equipment, the hydraulic circuit system comprising:
a hydraulic pump and a pilot pump;
a hydraulic cylinder driven by hydraulic fluid supplied by the hydraulic pump;
a directional control valve disposed on a path between the hydraulic pump and the hydraulic cylinder to control a flow of hydraulic fluid supplied to and discharged from the hydraulic cylinder;
a control device disposed on a path between the pilot pump and the directional control valve to output a control signal to control the directional control valve;
a central bypass control valve disposed farthest downstream of a central bypass passage connected to the hydraulic pump, the central bypass control valve switched to close an opening thereof when receiving pilot pressure applied by the control device;
a pressure sensor detecting hydraulic pressure of hydraulic fluid on a large chamber side of the hydraulic cylinder;
a jack-up control valve disposed on a path between the control device and the central bypass control valve, the jack-up control valve switched to allow the control device to apply the pilot pressure to the central bypass control valve when receiving a first electrical signal; and
a flow control valve disposed in the directional control valve, wherein, in a retraction operation of the hydraulic cylinder, the flow control valve is switched to an on position to block a flow of hydraulic fluid from the hydraulic pump to a small chamber of the hydraulic cylinder when the hydraulic pressure of hydraulic fluid on the large chamber side exceeds a preset pressure and is switched to open an opening thereof to allow the flow of hydraulic fluid from the hydraulic pump to the small chamber of the hydraulic cylinder when the hydraulic pressure of hydraulic fluid on the large chamber side is equal to or lower than the preset pressure.

2. The hydraulic circuit system of claim 1, further comprising a controller, wherein, in the retraction operation of the hydraulic cylinder, when the hydraulic pressure of hydraulic fluid on the large chamber side of the hydraulic cylinder is equal to or lower than the preset pressure, the controller applies the first electrical signal to the jack-up control valve to switch the jack-up control valve to close the opening of the central bypass control valve and applies a second electrical signal to a regulator controlling a swash plate angle of the hydraulic pump.

3. The hydraulic circuit system of claim 1, further comprising a load check valve disposed on a path between the hydraulic pump and a meter-in port of the directional control valve to prevent a reverse flow of hydraulic fluid if load pressure generated in the hydraulic cylinder is greater than hydraulic pressure of hydraulic fluid supplied by the hydraulic pump.

4. The hydraulic circuit system of claim 1, wherein the flow control valve comprises a pilot-operated control valve that switches between an initial position to allow the flow of hydraulic fluid from the hydraulic pump to the small chamber of the hydraulic cylinder to drive the hydraulic cylinder to retract and the on position to block the flow of hydraulic fluid from the hydraulic pump to the small chamber of the hydraulic cylinder in the retraction operation of the hydraulic cylinder.

5. The hydraulic circuit system of claim 1, wherein the jack-up control valve comprises a pilot-operated control valve that switches between an initial position in which an opening thereof is opened when the hydraulic pressure of hydraulic fluid on the large chamber side of the hydraulic cylinder is equal to or lower than the preset pressure and an on position in which the opening is closed when the hydraulic pressure of hydraulic fluid on the large chamber side of the hydraulic cylinder is higher than the preset pressure.

6. The hydraulic circuit system of claim 1, wherein the directional control valve has a regeneration passage through which the small chamber is supplemented with a portion of hydraulic fluid discharged from the large chamber in the retraction operation of the hydraulic cylinder.

7. The hydraulic circuit system of claim 6, wherein the regeneration passage has an orifice disposed therein, the orifice generating pilot pressure in the regeneration passage from the hydraulic fluid discharged from the large chamber to close the opening of the flow control valve by switching the flow control valve in the retraction operation of the hydraulic cylinder.

8. A hydraulic circuit system for construction equipment, the hydraulic circuit system comprising:
a hydraulic pump and a pilot pump;
a hydraulic cylinder driven by hydraulic fluid supplied by the hydraulic pump;
a directional control valve disposed on a path between the hydraulic pump and the hydraulic cylinder to control a flow of hydraulic fluid supplied to and discharged from the hydraulic cylinder;
a control device disposed on a path between the pilot pump and the directional control valve to output a control signal to control the directional control valve;
a pressure sensor detecting hydraulic pressure of hydraulic fluid on a large chamber side of the hydraulic cylinder;
a central bypass control valve disposed farthest downstream of a central bypass passage connected to the hydraulic pump, the central bypass control valve being switched to close an opening of a passage thereof when receiving pilot pressure;
a control valve disposed on a path between the pilot pump and the central bypass control valve, the control valve converting hydraulic fluid supplied by the pilot pump to the pilot pressure and applying the converted pilot pressure to the central bypass control valve when receiving a first electrical signal; and
a flow control valve disposed in the directional control valve, wherein, in a retraction operation of the hydraulic cylinder, the flow control valve is switched to an on position to block a flow of hydraulic fluid from the hydraulic pump to a small chamber of the hydraulic cylinder when the hydraulic pressure of hydraulic fluid on the large chamber side exceeds a preset pressure and is switched to open an opening thereof to allow the flow of hydraulic fluid from the hydraulic pump to the small chamber of the hydraulic cylinder when the hydraulic pressure of hydraulic fluid on the large chamber side is equal to or lower than the preset pressure.

9. The hydraulic circuit system of claim 8, further comprising a controller, wherein, in the retraction operation of the hydraulic cylinder, when the hydraulic pressure of hydraulic fluid on the large chamber side of the hydraulic cylinder is equal to or lower than the preset pressure, the controller applies the first electrical signal to the control valve to switch the control valve to close the opening of the central bypass control valve and applies a second electrical signal to a regulator controlling a swash plate angle of the hydraulic pump.

10. The hydraulic circuit system of claim 8, wherein the control valve comprises an electro proportional pressure reducing valve that converts the hydraulic fluid supplied by the pilot pump to the pilot pressure corresponding to the first electrical signal applied by a controller and applies the converted pilot pressure to the central bypass control valve.

11. The hydraulic circuit system of claim 8, wherein the control valve comprises a solenoid valve that is switched between an initial position to open the opening of the central bypass control valve and an on position to close the opening of the central bypass control valve by applying the hydraulic fluid supplied by the pilot pump, as the pilot pressure, to the central bypass control valve in response to the first electrical signal applied by the controller.

12. The hydraulic circuit system of claim 8, further comprising a first pressure sensor and a second pressure sensor disposed on paths between the control device and the directional control valve to detect pilot pressures applied to the directional control valve when the control device is operated and input signals to the controller to enable the hydraulic pump to supply the hydraulic fluid to the hydraulic cylinder at a flow rate corresponding to a degree to which the control device is operated.
